(19) United States
(12) Patent Application Publication
(10) Pub. No.: US 2017/0088698 A1
(43) Pub. Date: Mar. 30, 2017

(54) CELLULOSE ESTER MATERIALS WITH TUNABLE DEGRADATION CHARACTERISTICS

(71) Applicant: Eastman Chemical Company, Kingsport, TN (US)

(72) Inventors: Nick Allen Collins, Fall Branch, TN (US); Kenneth Flint, Roanoke, VA (US); Koushik Ghosh, Kingsport, TN (US); Jacob Donald Goodrich, Johnson City, TN (US); SM Bedarul Islam, Kingsport, TN (US); Brian Douglas Seiler, Kingsport, TN (US); Steven Anthony Wilson, Kingsport, TN (US)

(73) Assignee: Eastman Chemical Company, Kingsport, TN (US)

(21) Appl. No.: 15/268,661

(22) Filed: Sep. 19, 2016

Related U.S. Application Data
(60) Provisional application No. 62/233,753, filed on Sep. 28, 2015.

(51) Int. Cl. C08L 1/12; D01D 1/02; D01D 5/04; D01F 2/28; C09K 8/68

(52) U.S. Cl. CPC C08L 1/12; D01F 2/28; C09K 8/68; D01D 5/04; D01D 1/02; C09K 2208/08

(57) ABSTRACT

Degradable materials are provided that may be utilized in various wellbore treatment fluids, such as hydraulic fracturing fluids. In particular, the degradable materials can be formed from cellulose esters that are capable of effectively degrading at specific rates when exposed to the aqueous environments commonly found in wellbores. More particularly, the degradable materials can be in the form of degradable fibers that are formed from the cellulose esters described herein.

### FIELD OF THE INVENTION

The present invention relates to cellulose ester materials that are substantially degradable in aqueous environments. More particularly, the invention concerns cellulose ester materials that have been made to degrade at a specific rate in a specific environment.

### BACKGROUND

Many applications exist for materials that start with a certain set of physical characteristics, but later degrade into a form that does not interfere (physically or chemically) with the environment around it. For example, degradable fibers have been used in the oil and gas industry for various downhole procedures that require certain physical characteristics only during the performance of the operation.

Well drilling, cementing, and hydraulic fracturing operations can all benefit from the use of degradable materials. During drilling and cementing, degradable materials can be used, for example, to control fluid loss. During hydraulic fracturing, degradable materials can be used, for example, to aid in proper transport and placement of proppants.

Degradable materials can also be used as temporary blocking or sealing agents that prevent or greatly reduce flow into undesired zones. During well stimulation operations, one zone or stage can be isolated from another by using a dissolvable or degradable ball that sits on a plug, typically bored through, placed in the wellbore. The seal formed between the ball and its seat on the plug temporarily prevents flow through plug forcing well stimulation fluids into the desired zone or stage. The seat upon which the ball sits or even the plug itself may also be made out of such degradable materials. During initial well stimulation or especially restimulation it is also desirable to temporarily prevent flow into previously stimulated or fractured zones using a diverting agent. Such diverting agents can take many forms such as size, shape, etc. and their application with other fluids can be referred to as a “pill”. A key attribute of such diverting agents is that they degrade or dissolve after performing their temporary flow diversion function.

In the past, polylactic acid (PLA) fibers have been used in oil and gas operations because of their mechanical properties and because they degrade in subterranean environments after performance of a desired function. PLA is also readily available and more cost effective to use compared to many other degradable materials. Polylactic acid, however, has an upper temperature limit of about 120° C., above which PLA fibers tend to degrade too quickly, thereby minimizing their effectiveness when used in downhole operations.

Accordingly, there is a need to provide degradable material systems that can be used at temperatures where known fiber systems have not been successfully employed.

### SUMMARY

One or more embodiments of the present invention concern a composition comprising a degradable material at least partially formed of at least one cellulose ester having a total degree of substitution of 2.5 or lower. The degradable material exhibits a percent weight loss of not more than 50 percent after 0.25 days at 130° C. in deionized water and a percent weight loss of at least 65 percent after 7 days at 130° C. in deionized water. In addition, the cellulose ester has a degradation promoter content of 10 wt % or less.

One or more embodiments of the present invention concern a hydraulic fracturing method. The method comprises: (a) injecting a slurry comprising a carrier fluid, a proppant, and a degradable material into a wellbore in a subterranean formation, wherein the degradable material comprises a cellulose ester; (b) pressurizing the slurry to thereby form fractures in a portion of the subterranean formation having a temperature exceeding 130° C.; and (c) introducing the proppant and the degradable material into the fractures. In addition, the degradable material has a degradation promoter content of 10 wt % or less and the cellulose ester comprises cellulose acetate, cellulose propionate, cellulose butyrate, cellulose acetate butyrate, cellulose acetate propionate, cellulose acetate phthalate or a combination thereof.

One or more embodiments of the present invention concern a method for producing a degradable fiber. Generally, the method comprises: (a) dissolving a cellulose ester having a total degree of substitution of 2.5 or less in a spinning solvent to form a dope; and (b) spinning the dope to form the degradable fiber, wherein the degradable fiber exhibits a percent weight loss of not more than 50 percent after 0.25 days at 130° C. in deionized water and a percent weight loss of at least 65 percent after 7 days at 130° C. in deionized water.

### DETAILED DESCRIPTION

Certain embodiments of the present invention provide a material that degrades at a desirable rate in a hot, pressurized, and/or high ionic strength environment, such as, for example, the environment found in certain oil and gas wells. The degradable material can be useful in a variety of different forms, such as, for example, fibers, films, particles, or flakes.

The degradation rate of the degradable material may vary depending on the particular application. In general, however, it is desired for the material to substantially maintain its physical integrity during the particular operation being performed, but then degrade fairly rapidly and completely after the operation has been completed in order to permit later operations where the presence of the intact physical material is not desired. For example, a degradable material can be very helpful during a hydraulic fracturing operation for facilitating proper transport and placement of proppants. However, after fracturing, the continued presence of the degradable material can delay or inhibit production of hydrocarbons from the well. Thus, it is desirable for the degradable material to completely degrade in a relatively rapid fashion after fracturing is completed.

The rate of degradation of materials depends on a number of physical and chemical factors of both the degradable material and the environment around the degradable material. Physical factors of the degradable material that may affect its degradation rate include, for example, shape, dimensions, roughness, and porosity. Physical factors of the environment that may affect degradation rate include, for example, temperature, pressure, and agitation. Of course, the relative chemical make-up of the degradable material and the environment within which it is placed can greatly influence the rate of degradation of the material. For example, some materials degrade rapidly in hydrocarbons, but not in aqueous environments, while other materials degrade rapidly in aqueous environments, but not in hydrocarbons.

In certain embodiments, the degradable materials of the present invention degrade fast enough to exhibit a percent weight loss of at least 25, 40, 50, 65, 75, 80, 85, 90, 95, 98, 99, or 100 percent at 18, 14, 10, 7, 6, 4, 3, 2, or 1 days. Additionally or alternatively, the degradable material can degrade slow enough to exhibit a percent weight loss of not more than 50, 45, 40, 35, 30, 25, 20, 15, 10, or 5 weight percent at 0.05, 0.1, 0.25, 0.5, 0.75, 1, or 2 days. The foregoing degradation rates can apply to any environment within which the degradable material is employed. However, in one or more embodiments, the degradable material can exhibit the foregoing degradation rates when employed in an environment of deionized water that is maintained in the liquid phase at a temperature of 130° C. and atmospheric pressure.

In other embodiments, the degradable material exhibits the foregoing degradation rates in an aqueous medium having a relatively high temperature, high pressure, and/or high ionic strength. Such conditions are commonly found in subterranean wells. Accordingly, the aqueous medium in which the degradable material exhibits the foregoing degradation rates can comprise at least 25, 50, 75, 90, or 95 percent water. The temperature of the aqueous medium can be at least 100° C., 110° C., 120° C., 130° C., 140° C., or 150° C. The pressure of the aqueous medium can be at least 1.25 atmospheres, 2 atmospheres, 4 atmospheres, 6 atmospheres, 8 atmospheres, or 10 atmospheres. The ionic strength of the aqueous medium can be at least 0.01 M, 0.05 M, 0.1 M, or 0.2 M.

In various embodiments of the present invention, the degradable material comprises a cellulose ester. More specifically, the degradable material described herein can comprise degradable materials formed from a cellulose ester. As described below, it has been observed that degradable materials formed from cellulose esters can ideally degrade, both chemically and physically, when subjected to the conditions present in oil and gas wells.

In particular, the semisynthetic cellulose ester materials described herein can address the aforementioned deficiencies associated with other degradable materials. For example, these materials can be produced on a more economic scale compared to the special grades of lactide polymers that have been designed for use in hot or deep wells. Furthermore, cellulose ester materials can have a substantial amount of bio-content (typically derived from wood pulp or cotton linters) and can degrade into innocuous substances, primarily water soluble carbohydrates and organic acids, thereby making them more environmentally friendly.

We have unexpectedly discovered that certain compositions of cellulose esters function efficiently when utilized as degradable materials in fluid formulations for well treatment regimens that are commonly used in oil and gas production, and particularly in hydraulic fracturing fluids. For example, it has been observed that dry-spun forms of cellulose ester materials with minor modifications (such as cutting, bundling, etc.) can function effectively in many of the aqueous fluids used in the drilling and treatment of wells for oil and gas production.

Although not wishing to be bound by theory, it was unexpected for certain cellulose esters to degrade as well as they did in the aqueous wellbore environments due to relative stability of the cellulose ester backbone. It is believed that the use of certain cellulose esters, such as specific cellulose acetates, can create an acidic environment immediately around the cellulose ester when they degrade in such harsh environments, which can facilitate the hydrolysis and subsequent degradation of the cellulose ester.

Cellulose esters are well known compounds. Examples of cellulose esters include cellulose acetate (CA), cellulose propionate (CP), cellulose butyrate (CB), cellulose acetate propionate (CAP), and cellulose acetate butyrate (CAB). Cellulose esters are generally prepared by first converting cellulose to a cellulose triester before hydrolyzing the cellulose triester in an acidic aqueous media to the desired degree of substitution (DS) (i.e., average number of substituents per anhydroglucose monomer unit).

In various embodiments, the degradable material, such as the degradable fibers, can comprise at least 10, 25, 35, 50, 70, 75, 80, 85, 90, 95, 99, or 100 weight percent of one or more cellulose esters. In certain embodiments, the degradable material can “consist essentially of” or “consist of” one or more cellulose esters. In other embodiments, a single cellulose ester makes up at least 75, 90, 95, 99, or 100 percent of the total weight of the degradable materials.

Since cellulose esters are generally produced from highly-purified cellulose, various compositional attributes (including molecular weight, polydispersity, acyl constituent type, acyl degree of substitution, etc.) can be modified, which in turn can provide means for controlling the degradation rate of the materials in the hotter well environments. Thus, there are many different ways to modify the degradation properties of the cellulose ester.

For instance, composition variations of the cellulose esters can be used to control the resulting degradation rates. In particular, the acyl degree of substitution (DS) of the cellulose ester can greatly impact the degradation rate of materials derived therefrom. The DS for a particular type of acyl group can have a relatively large impact on the degradation rate and the theoretical maximum value for the DS is 3.0 (based on anhydroglucose representing the repeat unit for cellulose, as is a common theoretical treatment).

In various embodiments of the present invention, the cellulose ester can have a Total DS of at least 0.5, 1.0, 1.5, 1.8, 1.9, 2.0, 2.1, 2.2, 2.3, 2.4, 2.5, 2.6, 2.7, 2.8, or 2.9. Additionally or alternatively, the cellulose ester can have a Total DS of not more than 3.0, 2.9, 2.8, 2.7, 2.6, 2.5, 2.4, 2.3, 2.2, 2.1, 2.0, 1.9, 1.8, 1.7, 1.6, or 1.5.

Furthermore, the cellulose esters of the present invention can include one or more acyl groups. For example, the cellulose esters can comprise acyl groups including aliphatic and/or aromatic C₂-C₁₂ substituents. In various embodiments, the cellulose esters can comprise an acetate, a propionate, a butyrate, an aromatic-containing acyl group, or combinations thereof. In certain embodiments, the cellulose esters comprise acetate and/or propionate. Examples of cellulose esters that can be used in the present invention include cellulose acetate, cellulose propionate, cellulose butyrate, cellulose acetate propionate, cellulose acetate butyrate, and combinations thereof. As discussed further below, a particularly useful cellulose ester in the present invention is cellulose acetate.

In one or more embodiments, a cellulose acetate can make up at least 25, 50, 75, 90, or 100 percent of the total weight of the cellulose esters forming the degradable materials. In other embodiments, a cellulose acetate propionate makes up less than 75, 50, 25, 10, 5, or 1 percent of the total weight of the cellulose esters forming the degradable materials. In certain embodiments, the degradable materials do not contain a cellulose acetate propionate.

In various embodiments, the cellulose esters can comprise a mixed cellulose ester. As used herein, a “mixed cellulose ester” refers to a cellulose ester comprising at least two different acyl substituents. Examples of mixed cellulose esters include cellulose acetate propionate and cellulose acetate butyrate. In certain embodiments, the mixed cellulose esters can comprise a higher DS for one of the acyl substituents relative to the other acyl substituent. For example, the cellulose esters can have a higher DS of acetate compared to a DS of propionate. In certain embodiments, the mixed cellulose esters can have a DS of acetate of at least 0.5, 1, 1.5, 2, or 2.5 and/or a DS of propionate of less than 2.5, 2, 1.5, 1, 0.5, or 0.1.

As mentioned above, the DS of the specific acyl substituents on the cellulose esters can affect the resulting degradation rate of the degradable material. Thus, in various embodiments, the cellulose esters can have a DS for a specific acyl substituent of at least 0.5, 1.0, 1.5, 1.8, 1.9, 2.0, 2.1, 2.2, 2.3, 2.4, 2.5, 2.6, 2.7, 2.8, or 2.9. Additionally or alternatively, the cellulose esters can have a DS for a specific acyl substituent of not more than 3.0, 2.9, 2.8, 2.7, 2.6, 2.5, 2.4, 2.3, 2.2, 2.1, 2.0, 1.9, 1.8, 1.7, 1.6, or 1.5.

In addition, molecular weight and molecular weight distribution properties of the cellulose can also be expected to impact degradation rates, and as such, these polymer properties can also be used as control variables for adjusting degradation rates. For example, the cellulose esters can have a weight average molecular weight in the range from 1,500 to 850,000, 40,000 to 200,000, or 55,000 to 160,000. The cellulose esters can also have a number average molecular weight (“Mₙ”) in the range of from about 10,000 Da to about 200,000 Da, or 15,000 Da to about 60,000 Da. Additionally or alternatively, the cellulose esters can have a polydispersity in the range from 1.2 to 7, 1.5 to 5, or 1.8 to 3. Furthermore, in various embodiments, the cellulose esters can have a degree of polymerization (DP) of at least 5, 10, 25, or 50 and/or not more than 500, 250, 100, or 75.

Additionally, the preferential placement of the particular acyl substituents at the C2, C3, and C6 positions on the cellulose ester may also have an effect on the resulting degradation rates of the materials. Cellulose esters containing preferential placement of acyl substituents at the C2, C3, and C6 positions may be referred to as “regioselectivity substituted” cellulose esters. Regioselectivity substituted cellulose esters are described in U.S. Patent Application Publication No. 2010/0029927 and U.S. Pat. No. 8,729,253, the disclosures of which are incorporated herein by reference in their entireties. Generally, regioselectivity can be measured by determining the relative degree of substitution (RDS) using carbon 13 NMR. In various embodiments, the cellulose esters can comprise a regioselectively substituted cellulose ester that has an RDS ratio for one or more acyl substituents, for example, of C6>C2>C3, C6>C3>C2, C2>C3>C6, C3>C2>C6, C2>C6>C3, or C3>C6>C2, wherein C2, C3, and C6 represent the DS of the specific acyl substituent at that position.

The cellulose esters can be amorphous, semi-crystalline, or crystalline. In one or more embodiments, the cellulose esters used in the present invention are semi-crystalline.

Physical dimensions of the degradable materials can also be expected to impact their degradation rates. When the degradable materials are in the form of fibers, such physical dimensions can include, for example, fiber length, fiber diameter, and cross-sectional shape.

For instance, the degradable fibers can have an average length of at least 0.1, 0.25, 0.5, 1, 2, 3, 4, or 5 mm and/or not more than 100, 75, 50, 40, 30, or 25 mm. Additionally or alternatively, the degradable fibers can have a denier of at least 0.1, 0.5, 1, 5, 10, 50, 100, 250, 500, 750, 1,000, or 1,500 and/or not more than 5,000, 4,500, 4,000, 3,500, 3,000, 2,500, 2,000, 1,000, 500, or 100. Furthermore, the degradable fibers can have an average diameter of at least 0.5, 1, 2, 5, 10, or 25 and/or not more than 500, 250, 100, or 75 microns.

Further, in various embodiments, the degradable fibers can have an average longitudinal aspect ratio of at least 1, 2, 5, or 10 and/or not more than 5,000, 4,000, 3,000, 2,000, or 1,000. As used herein, the “longitudinal aspect ratio” refers to the average length of the fiber divided by the average diameter of the fiber. Additionally or alternatively, the degradable fibers can have a transverse aspect ratio of at least 0.1, 0.5, 0.75, 1, or 1.5 and/or not more than 10, 7, 5, or 2. As used herein, the “transverse aspect ratio” denotes the ratio of a fiber's maximum transverse dimension (width) to the fiber's minimum transverse dimension (thickness).

Furthermore, in various embodiments, the degradable fibers can have a round cross-sectional shape, an octagonal cross-sectional shape, an irregular cross-sectional shape, a lobed cross-sectional shape, an oval cross-sectional shape, a triangle cross-sectional shape, a square cross-sectional shape, or any other cross-sectional shape commonly used in the art. In certain embodiments, the degradable fibers can have a substantially round cross-sectional shape.

In certain embodiments of the present invention, the cellulose ester fiber can be in the form of a multifilament yarn comprising a denier per filament (dpf) of at least 0.1, 0.5, 1, 2, 3, 4, 5, 6, 7, 8, 9, or 10 and/or not more than 1,000, 750, 500, 250, 100, or 50.

Another means of modifying the degradation properties of cellulose ester materials can be provided through the use of additives, some of which enter in the course of manufacturing the cellulose ester polymers and others which can be added to the spinning solutions (dopes) used to form the materials. Examples of additives that can be used include sulfur-based compounds, plasticizers, clays, carbonates, titanium dioxide, titanium oxide, sodium carbonate, calcium carbonate, acetone soluble organic acids (e.g., citric acid), or combinations thereof. For instance, the cellulose esters used to produce the degradable materials can comprise at least 0.5, 1, 3, 5, 8, or 10 and/or not more than 30, 25, 20, or 15 weight percent of one or more additives. In certain embodiments, the cellulose esters used to produce the degradable materials can comprise at least 0.5, 1, 3, 5, 8, or 10 and/or not more than 30, 25, 20, or 15 weight percent of citric acid or sulfate. In certain embodiments, the cellulose esters used to produce the degradable materials can comprise at least 0.5, 1, 3, 5, 8, or 10 and/or not more than 30, 25, 20, or 15 weight percent of citric acid. In certain embodiments, the cellulose esters used to produce the degradable materials can comprise at least 0.5, 1, 3, 5, 8, or 10 and/or not more than 30, 25, 20, or 15 weight percent of sulfate.

In various embodiments, the degradation properties of the cellulose ester materials can be modified through the use of a degradation promoter, which can be added to the degradable material during the spinning process. For example, the degradation promoter can be selected from the group consisting of an inorganic acid, an inorganic salt, an inorganic base, an organic base, an organic acid, an organic salt, and combinations thereof. As used herein, a “degradation promoter” refers to any material whose addition to a cellulose ester, for example cellulose acetate, causes an increase in the rate of degradation of the cellulose acetate material in deionized water at 130° C.

In one embodiment, the degradation promoter is an organic acid, inorganic acid, salt of an organic acid, salt of an inorganic acid or combinations thereof. In one or more embodiments, the degradable materials can comprise less than 10 wt %, 9 wt %, 8 wt %, 7 wt %, 6 wt %, 5 wt %, 4 wt %, 3 wt %, 2 wt %, 1 wt % or 0.5 wt % of one or more degradation promoters.

In certain embodiments, the degradation promoter can be selected from the group consisting of hydrochloric acid, nitric acid, phosphoric acid, sulfuric acid, sulfurous acid, boric acid, hydrofluoric acid, hydrobromic acid, chloric acid, perchloric acid, nitric acid, nitrous acid, phosphate, sulfate, sulfite, borate, chlorate, phosphate, perchlorate, nitrate, nitrite, formic acid, acetic acid, propionic acid, butyric acid, valeric acid, citric acid, tartaric acid, oxalic acid, lactic acid, malic acid, benzoic acid, formate, acetate, propionate, butyrate, valerate citrate, tartarate, oxalate, lactate, malate, maleic acid, maleate, phthalic acid, phthalate, benzoate, and combinations thereof. Alternatively, the degradation promoter can be selected from the group consisting of hydrochloric acid, nitric acid, phosphoric acid, sulfuric acid, sulfurous acid, boric acid, hydrofluoric acid, hydrobromic acid, chloric acid, perchloric acid, nitric acid, nitrous acid, phosphate, sulfate, sulfite, borate, chlorate, phosphate, perchlorate, nitrate, nitrite, formic acid, acetic acid, propionic acid, butyric acid, valeric acid, citric acid, tartaric acid, oxalic acid, malic acid, benzoic acid, formate, acetate, propionate, butyrate, valerate citrate, tartarate, oxalate, malate, maleic acid, maleate, phthalic acid, phthalate, benzoate, and combinations thereof.

For example, in various embodiments, the degradation promoter can comprise a sulfate and/or citric acid. In one or more embodiments, the degradable materials can comprise less than 20 wt %, 17 wt %, 15 wt %, 13 wt %, 10 wt %, 9 wt %, 8 wt %, 7 wt %, 6 wt %, 5 wt %, 4 wt %, 3 wt %, 2 wt %, 1 wt % or 0.5 wt % of one or more degradation promoters.

Furthermore, soluble chemical agents can be added to spinning dopes, or insoluble agents can be placed in suspension, so that they are incorporated into the degradable materials for controlling ultimate degradation rate. An example of a soluble chemical agent is sodium carbonate and an example of an insoluble agent is titanium oxide.

In certain embodiments, the cellulose ester fibers and the degradable materials formed therefrom do not contain a plasticizer. More specifically, the cellulose esters and the degradable materials formed therefrom can comprise less than 2, 1, 0.5, 0.1, or 0.01 weight percent of a plasticizer.

An example of an additive remaining from the manufacturing of the cellulose esters would include residual sulfates and/or other polar compounds. Sulfuric acid is commonly used as a catalyst in the manufacture of cellulose esters, and ultimately, the residual acid is neutralized. Subsequently, the sulfate salts are purged through extensive washing, and manufacturing procedures can be used to control the amount of residual sulfur. The sulfur level present in the isolated cellulose ester can dictate, to a certain extent, the hydrolytic stability of fibers spun therefrom. In various embodiments, the cellulose esters have a residual sulfur and/or polar compound content of less than 10 wt %, 9 wt %, 8 wt %, 7 wt %, 6 wt %, 5 wt %, 4 wt %, 3 wt %, 2 wt %, 1 wt %, 0.75 wt %, 0.5 wt %, 0.4 wt %, 0.3 wt %, 0.2 wt %, 0.15 wt %, 0.1 wt %, 0.05 wt %, or 0.01 wt %. Additionally or alternatively, the cellulose esters can comprise sulfur in an amount of not more than 10 wt %, 5 wt %, 2.5 wt %, or 1 wt % based on the total weight of the cellulose esters in the degradable material.

Although additives may be added to the degradable materials, these additives may not be in the form of a coating. In certain embodiments, the degradable materials do not comprise a coating.

As noted above, we have unexpectedly discovered that certain compositions of spun cellulose esters can function efficiently when used as degradable materials in well treatment fluids commonly applied to enhance oil and gas production, and particularly in hydraulic fracturing fluids. Many fiber spinning methods, including wet-spinning, dry-spinning, melt-spinning, and electro-spinning, can be used to form fibers from the cellulose esters. Thus, the degradable materials described herein can be produced using any one of these spinning methods.

In certain embodiments of the present invention, the cellulose ester materials are produced via dry-spinning. Drying-spinning, as commonly practiced, allows for facile adjustment of the physical dimension aspects of the fibers, and this technique also opens up possibilities for including thermally-labile additives. Generally, dry-spinning involves spinning a concentrated solution of cellulose ester dissolved in a solvent through a spinneret consisting of many small holes into hot air, where the solvent quickly evaporates thereby leaving fibrous strands. While alternative means of manufacture exist for some of the compositions, dry-spinning generally represents a cost-effective means of producing the degradable fibers at high speeds and largescale volumes.

In various embodiments of the present application, the degradable materials can comprise a dry-spun, unplasticized cellulose acetate. It has been observed that these materials have advantages over prior art materials (PLA and the like) in that they degrade appreciably slower, but predictably, at higher temperatures and pressures, which reflect the conditions encountered in hotter wells (e.g., temperatures in excess of 130° C.).

In certain embodiments of the present application concerns a method for producing a degradable fiber, the method comprises: (a) dissolving a cellulose ester having a total degree of substitution of 2.9 or less in a spinning solvent to form a dope; and (b) spinning said dope to form said degradable fiber, wherein said degradable fiber exhibits a percent weight loss of not more than 25 percent after 0.25 days at 130° C. in deionized water and a percent weight loss of at least 65 percent after 7 days at 130° C. in deionized water.

Cellulose acetate is thought to be among the most commercially useful derivatives of cellulose, and its specific physical and chemical properties generally depend largely on the degree of substitution of acetate on the three free hydroxyl groups of a glucose monomer unit. Cellulose acetate materials can be dry-spun from cellulose acetates with DS_{acetyl} values of about 2.5 or lower from acetone solutions commonly called “dopes.” Generally, cellulose acetate polymers having a DS_{acetyl} of above 2.5 will exhibit very limited solubility in acetone. However, cellulose acetates with lower DS_{acetyl} values can be dry spun effectively, although solvent additives (including water) may be required for polymers with DS_{acetyl} of less than about 2.2. Exemplary solvents that may be used to form dopes with the cellulose acetates include water, acetone, methylethyl ketone, methylene chloride, dioxane, dimethyl formamide, methanol, ethanol, glacial acetic acid, supercritical CO₂, or combinations thereof.

It has been observed that the DS_{acetyl} value for cellulose acetate polymers can have a significant impact on the degradation rates of the materials derived therefrom and the impact is very apparent at temperatures/pressures commonly experienced in oil and gas well environments. Thus, in various embodiments, the cellulose esters can have a DS_{acetyl} of at least 0.5, 1.0, 1.5, 1.8, 1.9, 2.0, 2.1, 2.2, 2.3, 2.4, 2.5, 2.6, 2.7, 2.8, or 2.9. Additionally or alternatively, the cellulose esters can have a DS_{acetyl} of not more than 3.0, 2.9, 2.8, 2.7, 2.6, 2.5, 2.4, 2.3, 2.2, 2.1, 2.0, 1.9, 1.8, 1.7, 1.6, or 1.5.

As discussed further below, the degradable materials described herein, in particular the cellulose ester fibers, can be used in wellbore treatment fluids useful in various gas and oil applications. For example, the wellbore treatment fluids can be in the form of slurries and be selected from the grouping consisting of a hydraulic fracturing fluid, a drilling fluid, a channelant formation agent, a completion fluid, a flowback control agent, a proppant transport fluid, a viscosifier extension agent, a plug flow agent, or a fluid carrier. In certain embodiments, the degradable cellulose ester materials described herein can be used in a hydraulic fracturing fluid, which can also comprise a proppant and carrier fluid.

The wellbore treatment fluids can comprise at least 0.1, 0.5, 1, 2, 3, 4, 5, 6, 7, 8, 9, 10, 15, 20, 25, 30, 35, 40, 45, 50, 55, 60, 65, or 70 weight percent of the degradable materials described herein. Additionally or alternatively, the wellbore treatment fluids can comprise less than 99, 95, 90, 85, 80, 75, 70, 65, 60, 55, 50, 45, 40, 35, 30, 25, 20, 15, 10, 5, or 2.5 weight percent of the degradable materials described herein.

Any additives normally used in wellbore treatment fluids may also be included in the treatment fluids as long as they are compatible with the degradable materials described herein. Such additives can include, for example, antioxidants, crosslinkers, corrosion inhibitors, delay agents, biocides, buffers, fluid loss additives, and combinations thereof.

In various embodiments, the degradable materials described herein can be used by: (a) injecting a slurry comprising a carrier fluid, a proppant, and the degradable cellulose ester materials into a wellbore in a subterranean formation; (b) pressurizing the slurry to thereby form fractures in a portion of the subterranean formation having a temperature exceeding 130° C.; and (c) introducing the proppant and the degradable materials into the formed fractures. It should be noted that the temperatures in the wellbore can differentiate depending on a number factors including, geography and depth of the wellbore. For instance, the temperatures of the wellbores can exceed 130° C., 135° C., 140° C., 150° C., or 175° C.

Hydrocarbons (e.g., oil, condensate, and gas) are typically produced from wells that are drilled into the formations containing them. Often, for a variety of reasons, such as inherently low permeability of the formation or damage to the formation caused by drilling, the flow of hydrocarbons into the well is undesirably low. In such scenarios, the well is often “stimulated.” One of the most common forms of stimulation is hydraulic fracturing, in which a fluid is injected into the formation at a pressure above the “fracture” pressure of the formation. A fracture is formed and grows into the formation, greatly increasing the surface area through which fluids may flow into the well. When the injection pressure is released, the fracture closes. Consequently, a particulate material, often called a “proppant,” is included in the fracturing fluid so that when the pressure is released, the fracture cannot close completely, but rather closes on the proppant. Therefore, the formed fractures are held apart by a bed of proppant through which the fluids may then flow to the well. The fracturing fluid normally must have a minimal viscosity that serves two purposes. First, the more viscous the fluid the more readily the fracture will be widened by injection of the fluid, and, second, a more viscous fluid will more readily transport proppant, hence the term “carrier” fluid. However, when the fluid is viscosified with a polymer or fiber, as is often the case, at least some of the polymer or fiber is left in the fracture after the treatment. This viscosifier left in the fracture can inhibit the flow of desirable fluids out of the formation, through the fracture, into the wellbore, and to the surface for recovery.

The degradable materials described herein can be useful in the aforementioned fracturing applications, either in conjunction with any suitable hydraulic fracturing fluid, including a conventional fracturing fluid that includes a carrier fluid and a viscosifying agent or a fracturing fluid that comprises a cement composition. The degradable materials described herein are also useful in fracturing operations that do not involve a cement composition to form a proppant pack in a fracture having voids to increase its permeability. The degradable materials described herein may also be incorporated within a gravel pack composition so as to form a gravel pack down hole that provides some permeability from the degradation of the materials.

As described above, the degradable materials of the present invention will eventually degrade under the conditions utilized in hydraulic fracturing, thereby facilitating the flow of the desirable fluids out of the treated formation.

The degradable materials described herein can also be used as bridging agents in well treatment fluids to divert fluid flow and to stop the fluid loss. Typically, fibers used to treat hydrocarbon wells may need to be stable for several weeks, for example 1 to 2 weeks or 2 to 3 weeks at the downhole temperatures, until the well formation is complete. After the completion, these fibers should gradually degrade, either mechanically or chemically, to allow the fracture be reopened for oil or gas production. As previously discussed, in higher temperature conditions, the most commonly used commercial fibers are either too stable to allow fractures to reopen or too unstable that they degrade before well completion. In contrast, the cellulose ester materials described herein provide controlled degradation rates that are ideal for higher temperature wellbore applications.

### EXAMPLES

### Abbreviations

AcOH is acetic acid; ° C. is degree Celsius; CA is cellulose acetate; Dpf is denier per filament; h is hour(s); DS is degree substitution; lb(s) is pound(s); ppm is parts per million; g is gram(s); Kg is kilogram(s); L is liter; MgOAc is magnesium acetate; mL is milliliter; min is minute(s); μm is micrometer; N.M. is no measurement; Wt. is weight; PLA is polylactic acid; rt is room temperature; T_{g} is glass transition temperature; Tₘ is melting point; mm is millimeter(s); and μm is micrometer(s).

### Example 1—Fibers

### Experimental Procedure—Swagelok Tubing-Based Vessels

The hydrolytic stability of various fiber or film samples was measured by placing the fiber or film in air tight containers made with Swagelok fittings and tubing. The test mixtures consisted of fibers or film samples (0.25 g) added to unbuffered deionized water (25 g). The solutions were shaken to homogenize the dispersion, and the containers were heated at 130° C. for a desired time to allow for the degradation of the fiber or film samples, which can occur by the formation of water soluble or volatile compounds from the fiber or film samples. After aging, the mixture was filtered with a coarse glass frit and the remaining solid was dried (49° C., ˜2 h) to determine how much the fiber or film samples degraded. The dried solid was then allowed to cool to rt (1 h) and weighed.

### Comparative Examples

### Sample A: PLA Fibers

PLA-based fibers with a dpf of 1.5, a Tg of 58° C., a Tm of 169° C., and a length of 6 mm, were purchased from MiniFIBERS, Johnson City, Tenn.

### Sample B: Rayon Fibers

Textile grade Rayon fibers treated with a mineral oil-based lubricant and having a dpf of 1.8, a length of 6 mm, and cloud shape cross section were obtained from Cordenka.

Measurement of Sulfur/Sulfate Content:

The concentration of sulfate in the cellulosic polymers can be determined by measuring the sulfur content using an Optima 2100 DV Inductively Coupled Plasma Optical Emission Spectrometer ICP-OES (Perkin Elmer Corp, Norwalk, Conn.), because the sulfate and sulfur content are directly proportional. Polymer sample digestions were carried out on approximately 1 g samples of the cellulosic material, transferred into a 150 mL quartz beaker to which HNO₃ (10 mL) was added and heated (200° C., 2 h) or until the sample had completely digested. Once digested, the sample was quantitatively transferred using Millipore water to a 100 mL volumetric flask. A 1-ppm Scandium internal standard was added to each sample. The ICP-OES was calibrated at 1 ppm using matrix matched standards prepared from certified calibration standards purchased from High Purity Standards (Charleston, S.C.).

### Invention Examples—Fibers

### General Fiber Procedure

### Sample 1: Cellulose Acetate Fibers (DS=2.5, Fiber Thickness=˜30 μm, and Sulfur Content=137 ppm)

As an example of the invention, uncrimped cellulose acetate-based fibers were produced from Eastman™ cellulose acetate (CA-394-60S) polymer with a dry spinning process using acetone as a solvent. Other solvents that can be used include acetone/water solutions depending on the type of cellulose polymer. The fibers had ˜30 μm wide “Y” cross sections and lengths of 6 mm.

### Sample 2: Cellulose Acetate Fibers (DS=1.9, Fiber Thickness=˜30 μm, and Sulfur Content=47 ppm)

Uncrimped cellulose acetate-based fibers were produced from Eastman™ cellulose acetate (CA-320S NF/EP) polymer with a dry spinning process using a water and acetone solvent. The spinning solution was comprised of 25% cellulose acetate (DS=1.9), 0.5% TiO₂, 15% water, and 59.5% acetone. The fibers had 30-μm wide “Y” cross sections and lengths of 6 mm.

TABLE 1
Fiber Results - Hydrolysis at 130° C.

| | Comparative | Comparative | | |
|---|---|---|---|---|
| | Sample A | Sample B | Sample 1 | Sample 2 |
| Initial Wt. (%) | 100 | 100 | 100 | 100 |
| Residual Wt. (%) | 56.7 | 94.8 | 99.6 | 69.4 |
| after 1 day | | | | |
| Residual Wt. (%) | 0 | 90.5 | 89.7 | 1.8 |
| after 2 day | | | | |
| Residual Wt. (%) | 0 | 87.8 | 82.5 | 0 |
| after 3 day | | | | |
| Residual Wt. (%) | 0 | 85.6 | 77.7 | 0 |
| after 4 day | | | | |
| Residual Wt. (%) | 0 | 82.1 | 71.8 | 0 |
| after 5 day | | | | |
| Residual Wt. (%) | 0 | 81.8 | 59.1 | 0 |
| after 7 day | | | | |

### Example 2—Films

### Film Casting Condition

The films were cast on glass sheets that were 11 inches wide and 16 inches long, using a Gardco film casting blade set to 25 μm (wet film thickness). After drawing down the film, it was covered for 45 min with an aluminum cover. After 45 min the film was released from the glass and annealed for 15 min at 85° C. After annealing was complete, the film thickness and optical properties were measured. Film thickness was roughly around 30 μm due to shrinkage and the film drying.

### DS Series

### Sample 3: Cellulose Acetate Film (DS=2.5, Film Thickness=˜30 μm)

Sample 3 was prepared from Eastman™ cellulose acetate (CA-394-60S) polymer, which has a DS of 2.5 and sulfur content of 94 ppm. This cellulose acetate was cast into a film (thickness of ˜30 μm) via the method described above in Example 2.

### Sample 4: Cellulose Acetate Film (DS=2.2, Film Thickness=˜30 μm)

Sample 4 was prepared from a cellulose acetate having a DS of 2.2 and a sulfur content of 84 ppm, which was cast into a film (film thickness=˜30 μm) as described in Example 2. The cellulose acetate polymer used to cast the film was prepared by dissolving cellulose acetate (CA-394-60S, 29 lbs) in acetic acid (124 lbs) and demineralized water (53 lbs). The mixture mixed overnight (60° C.). Sulfuric acid (551 g) in AcOH (2 L) was added to the solution and the mixture was mixed (2.5 h) (i.e., the “Hydrolysis step”). The mixture was neutralized by addition of Mg(OAc)₂ (1.32 Kg) in demineralized water (20 lbs). The polymer was then precipitated by the addition of demineralized water (420 lbs). The slurry was filtered and washed with demineralized water (6×), and then washed with NaHCO₃ (500 lbs) in demineralized water (5000 lbs).

### Sample 5: Cellulose Acetate Film (DS=2.1, Film Thickness=˜30 μm)

Sample 5 was prepared by casting a film (film thickness=˜30 μm) from a cellulose acetate having a DS of 2.1 and sulfur content of 84 ppm via the method described in Example 2. The polymer used to cast the film was prepared according to the procedure described in Sample 4 except the hydrolysis step was performed for 5 h.

### Sample 6: Cellulose Acetate Film (DS=1.9, Film Thickness=˜30 μm)

Sample 6 was prepared by casting a film (film thickness=˜30 μm) from a cellulose acetate having a DS of 1.9 and sulfur content of 77 ppm via the method described in Example 2. The polymer used to cast the film was prepared according to the procedure described in Sample 4 except the Hydrolysis Step was performed for 8 h.

TABLE 2
Film Results - Hydrolysis at 130° C.

| | Sample 3 | Sample 4 | Sample 5 | Sample 6 |
|---|---|---|---|---|
| Initial Wt. (%) | 100 | 100 | 100 | 100 |
| Residual Wt. (%) | 99.2 | 83.4 | 79.5 | 44.1 |
| after 1 day | | | | |
| Residual Wt. (%) | 93.8 | 80.8 | 61.5 | 9.1 |
| after 2 days | | | | |
| Residual Wt. (%) | 84.5 | 75.3 | 48.8 | 0 |
| after 3 days | | | | |
| Residual Wt. (%) | 82.5 | 69.8 | 23.8 | 0 |
| after 4 days | | | | |
| Residual Wt. (%) | 78.3 | 60.6 | 3.4 | 0 |
| after 5 days | | | | |

### Example 3—Combined Sulfur Series

### General Procedure for High Sulfur Sample Preparation

A cellulose ester was dissolved in acetic acid (“dope solution”) while heating at 60° C. The solution was cooled to room temperature (ice bath). A slurry of acetic anhydride, acetic acid, sodium sulfate, and sulfuric acid was prepared based on the desired sulfate level of the final cellulose ester polymer and stirred for 30 min. The slurry cooled in an ice bath and was added to the dope solution and stirred for 20 min. The reaction was quenched until neutral with a mixture of sodium acetate (0.5 g), water (40 mL), and acetic acid (40 mL), and the resulting mixture was stirred (30 min). Subsequently, cellulose ester polymers with varying sulfur content were precipitated from the water, filtered, and washed with a continuous flow of water (12 h). The remaining cellulose ester polymer was centrifuged and then dried at 60° C. in an N₂ atmosphere for 12 h.

### Sample 7: Cellulose Acetate Film (DS=2.4, Film Thickness=˜30 μm, and Sulfur Level=334 ppm)

Sample 7 was prepared via the process described in Example 3 to obtain a cellulose acetate polymer having a DS of 2.4 and a sulfate level of 334 ppm, which was then film casted to obtain a film (film thickness=˜30 μm) via the process described in Example 2.

### Sample 8: Cellulose Acetate Film (DS=2.3, Film Thickness=˜30 μm, and Sulfur Level=1650 ppm)

Sample 8 was prepared by adapting the procedure of Example 3 to obtain a cellulose acetate polymer having a DS of 2.3 and a sulfate level of 1650 ppm, which was then casted into a film (film thickness=˜30 μm) via the process described in Example 2.

### Sample 9: Cellulose Acetate Film (DS=2.3, Film Thickness=˜30 μm, and Sulfur Level=3845 ppm)

Sample 9 was prepared by adapting the procedure of Example 3 to obtain a cellulose acetate polymer having a DS of 2.3 and a sulfate level of 3845 ppm, which was then casted into a film (film thickness=˜30 μm) via the process described in Example 2.

TABLE 3
Film Results - Hydrolysis at 130° C.

| | Sample 3 | Sample 7 | Sample 8 | Sample 9 |
|---|---|---|---|---|
| Initial Wt. (%) | 100 | 100 | 100 | 100 |
| Residual Wt. | 99.2 | 90.7 | 75.4 | 57.6 |
| (%) after 1 day | | | | |
| Residual Wt. | 93.8 | 84.8 | 76 | 38.9 |
| (%) after 2 day | | | | |
| Residual Wt. | 84.5 | 75.6 | 53.4 | 14.1 |
| (%) after 3 day | | | | |
| Residual Wt. | 82.5 | 61.6 | 50.7 | 8.6 |
| (%) after 4 day | | | | |
| Residual Wt. | 78.3 | 53.8 | 46.6 | 0 |
| (%) after 5 day | | | | |

### Example 4—Citric Acid Series

### General Procedure for Composite Film Preparation

The citric acid was dissolved in acetone by sonication. The cellulose ester dope (12 g cellulose ester in 100 g in acetone) was added to the degradant/acetone solution. The resulting mixture was subjected to high shear mixing to ensure proper mixing. The uniformity of the dispersion was confirmed by measuring the percent haze of cast films (Example 2). The percentage of citric acid in the final polymer was determined by calculating the weight gain.

### Sample 10: Cellulose Acetate Film (DS=2.5, Film Thickness=˜30 μm), 1% Citric Acid

Example 4 was adapted to prepare a 1% citric acid cellulose acetate (DS=2.5) composition by using a citric acid (0.12 g)/acetone (100 g) solution. Sample 10 was prepared by casting a film of the 1% citric acid/cellulose acetate material to form a film (film thickness=˜30 μm) via the process described in Example 2.

### Sample 11: Cellulose Acetate Film (DS=2.5, Film Thickness=˜30 μm), 3% Citric Acid

Example 4 was adapted to prepare a 3% citric acid cellulose acetate (DS=2.5) composition by using a citric acid (0.36 g)/acetone (100 g) solution. Sample 11 was prepared by casting a film of the 3% citric acid cellulose acetate material to form a film (film thickness=˜30 μm) via the process described in Example 2.

### Sample 12: Cellulose Acetate Film (DS=2.5, Film Thickness=˜30 μm), 10% Citric Acid

Example 4 was adapted to prepare a 10% citric acid cellulose acetate (DS=2.5) composition by using a citric acid (1.2 g)/acetone (100 g) solution. Sample 11 was prepared by casting a film of the 3% citric acid cellulose acetate material to form a film with the desired thickness (˜30 μm) via the process described in Example 2.

TABLE 4
Film Results - Hydrolysis at 130° C.

| | Sample 3 | Sample 10 | Sample 11 | Sample 12 |
|---|---|---|---|---|
| Initial Wt. (%) | 100 | 100 | 100 | 100 |
| Residual Wt. | 99.2 | 94.5 | 87.7 | 83.9 |
| (%) after 1 day | | | | |
| Residual Wt. | 93.8 | 87.8 | 84.8 | 69.1 |
| (%) after 2 day | | | | |
| Residual Wt. | 84.5 | 83.7 | 79.8 | 63.4 |
| (%) after 3 day | | | | |
| Residual Wt. | 82.5 | 81.5 | 74.6 | 57.6 |
| (%) after 4 day | | | | |
| Residual Wt. | 78.3 | 79.4 | 75.2 | 51.8 |
| (%) after 5 day | | | | |
| Residual Wt. | N.M. | 77.5 | 73.3 | 47.9 |
| (%) after 6 day | | | | |
| Residual Wt. | N.M. | 74.9 | 71.4 | 36.6 |
| (%) after 7 day | | | | |

### Example 5—Effects of Temperature on the Degradation Rates

The hydrolytic stability of various fiber or film samples was measured by placing the fiber in air tight containers made with Swagelok fittings and tubing.

The test mixtures consisted of fibers or film samples (0.25 g) added to unbuffered deionized water (25 g). The solutions were shaken to homogenize the dispersion and the containers were heated at 95° C., 105° C., or 130° C. After aging the samples, the remaining materials were filtered and the remaining solid was dried at 60° C. (˜6 h). The dried solids were allowed to cool to rt and then weighed.

TABLE 5

| | | | Sample | Sample | Sample | Sample |
|---|---|---|---|---|---|---|
| | Sample A | Sample 1 | A | 1 | A | 1 |
| Temp. | 95 | 95 | 105 | 105 | 130 | 130 |
| (° C.) | | | | | | |
| Initial Wt. | 100 | 100 | 100 | 100 | 100 | 100 |
| (%) | | | | | | |
| Residual | 97.7 | 98.9 | 92.3 | 99.3 | 56.7 | 99.6 |
| Wt. (%) | | | | | | |
| after 1 | | | | | | |
| day | | | | | | |
| Residual | N.M. | N.M. | 73.9 | 98.8 | 0 | 89.7 |
| Wt. (%) | | | | | | |
| after 2 | | | | | | |
| day | | | | | | |
| Residual | 96.5 | 93.5 | 53.4 | 95.6 | 0 | 82.5 |
| Wt. (%) | | | | | | |
| after 3 | | | | | | |
| day | | | | | | |
| Residual | N.M. | N.M. | N.M. | N.M. | 0 | 77.7 |
| Wt. (%) | | | | | | |
| after 4 | | | | | | |
| day | | | | | | |
| Initial Wt. | N.M. | N.M. | N.M. | N.M. | 0 | 71.8 |
| (%) after | | | | | | |
| 5 day | | | | | | |

### Example 6

Table 6 shows that films and fibers of comparable thickness (˜30 μm) and DS have a similar degradation profiles.

TABLE 6
Effects of Films and Fibers on the Degradation Rates of the Cellulose
Esters at 130° C.

| | Sample 1 | Sample 3 | Sample 6 | Sample 2 |
|---|---|---|---|---|
| Initial Wt. (%) | 100 | 100 | 100 | 100 |
| Residual Wt. (%) | 99.6 | 99.2 | 44.1 | 69.4 |
| after 1 day | | | | |
| Residual Wt. (%) | 89.7 | 93.8 | 9.1 | 1.8 |
| after 2 days | | | | |
| Residual Wt. (%) | 82.5 | 84.5 | 0 | 0 |
| after 3 days | | | | |
| Residual Wt. (%) | 77.7 | 82.5 | 0 | 0 |
| after 4 days | | | | |
| Residual Wt. (%) | 71.8 | 78.3 | 0 | 0 |
| after 5 days | | | | |
| Residual Wt. (%) | 61.8 | N.M | 0 | 0 |
| after 6 days | | | | |
| Residual Wt. (%) | 59.1 | N.M | 0 | 0 |
| after 7 days | | | | |

### Example 7

### Sample 13

Sample 13 was prepared by casting a film (film thickness=˜30 μm) from commercially available Eastman™ cellulose acetate CA 398-3 (Mn=20K with NMP as solvent) via the method described in Example 2.

### Sample 14

Sample 14 was prepared by casting a film (film thickness=˜30 μm) from commercially available Eastman™ cellulose acetate CA 398-6 (Mn=30K with NMP as solvent) via the method described in Example 2.

### Sample 15

Sample 15 was prepared by casting a film (film thickness=˜30 μm) from commercially available Eastman™ cellulose acetate CA 398-10 (Mn=35K with NMP as solvent) via the method described in Example 2.

### Sample 16

Sample 16 was prepared by casting a film (film thickness=˜30 μm) from commercially available Eastman™ cellulose acetate CA 398-30 (Mn=50K with NMP as solvent) via the method described in Example 2.

The hydrolytic stability of Samples 13-16 were studied at 130° C. in deionized water by adapting the procedure in Example 5. The results are in Table 7.

TABLE 7
Degradation results for Samples 13-16.

| | Sample 13 | Sample 14 | Sample 15 | Sample 16 |
|---|---|---|---|---|
| Initial Wt. (%) | 100 | 100 | 100 | 100 |
| Residual Wt. (%) | 99.2 | 97.4 | 96.7 | 95.2 |
| after 1 day | | | | |
| Residual Wt. (%) | 93.9 | 93.3 | 86 | 91.3 |
| after 2 days | | | | |
| Residual Wt. (%) | 85.6 | 89.2 | 80 | 83.5 |
| after 3 days | | | | |
| Residual Wt. (%) | 82.7 | 83.7 | 77.5 | 82.5 |
| after 4 days | | | | |
| Residual Wt. (%) | 80.3 | 80.5 | 65.3 | 67.5 |
| after 5 days | | | | |
| Residual Wt. (%) | 77.8 | 78.2 | 60.2 | 57.8 |
| after 6 days | | | | |
| Residual Wt. (%) | 71.8 | 70.5 | 56.8 | 51.8 |
| after 7 days | | | | |

### Example 8

### Sample 17: Cellulose Triacetate Film (DS=2.89, Film Thickness=˜30 μm), 10% Citric Acid

Example 8 was adapted to prepare a 10% citric acid commercially available Eastman™ cellulose acetate VM 149 (DS=2.89) composition by using a citric acid (1.2 g)/dichloromethane (100 g) solution. Sample 17 was prepared by casting a film of the 10% citric acid cellulose acetate material to form a film with the desired thickness (˜30 μm) via the process described in Example 2.

### Sample 18: Cellulose Triacetate Film (DS=2.89, Film Thickness=˜30 μm), 20% Citric Acid

Example 8 was adapted to prepare a 20% citric acid commercially available Eastman™ cellulose acetate VM 149 (DS=2.89) composition by using a citric acid (2.4 g)/dichloromethane (100 g) solution. Sample 18 was prepared by casting a film of the 20% citric acid cellulose acetate material to form a film with the desired thickness (˜30 μm) via the process described in Example 2.

The hydrolytic stability of Samples 17-18 were studied at 130° C. in deionized water by adapting the procedure in Example 5. The results are in Table 8.

TABLE 8
Degradation results for Samples 17-18.

| | Sample 17 | Sample 18 |
|---|---|---|
| Initial Wt. (%) | 100 | 100 |
| Residual Wt. (%) | 85.2 | 85.4 |
| after 2 days | | |
| Residual Wt. (%) | 81.9 | 81.3 |
| after 4 days | | |
| Residual Wt. (%) | 75.6 | 75.9 |
| after 6 days | | |
| Residual Wt. (%) | 68.7 | 65.8 |
| after 7 days | | |

1. A composition comprising degradable material at least partially formed of at least one cellulose ester having a total degree of substitution of 2.9 or less, wherein said cellulose ester has a degradation promoter content of 20 wt % or less, wherein said degradable material exhibits a percent weight loss of not more than 50 percent after 0.25 days at 130° C. in deionized water and a percent weight loss of at least 65 percent after 7 days at 130° C. in deionized water.

2. The composition of claim 1, wherein said cellulose ester comprises an acetate substituent, a propionate substituent, a butyrate substituent, or a combination thereof.

3. The composition of claim 1, wherein said cellulose ester comprises cellulose acetate.

4. The composition of any one of claims 1-3, wherein the cellulose ester has a number average molecular weight (“Mₙ”) in the range of from about 15,000 Da to about 60,000 Da.

5. The composition of claim 1, wherein said degradable material does not comprise a plasticizer.

6. The composition of claim 1, wherein said degradable material is in the form of degradable fibers.

7. The composition of any one of claims 1-3, wherein said composition comprises a wellbore treatment fluid.

8. The composition of claim 7, wherein said wellbore treatment fluid comprises a hydraulic fracturing fluid.

9. The composition of any one of claims 7-8, wherein said wellbore treatment fluid comprises in the range of 0.1 to 20 weight percent of said degradable material.

10. The composition of claim 1, wherein said degradable material consists of said cellulose ester.

11. The composition of claim 1, wherein said degradation promoter is selected from the group consisting of hydrochloric acid, nitric acid, phosphoric acid, sulfuric acid, sulfurous acid, boric acid, hydrofluoric acid, hydrobromic acid, chloric acid, perchloric acid, nitric acid, nitrous acid, phosphate, sulfate, sulfite, borate, chlorate, phosphate, perchlorate, nitrate, nitrite, formic acid, acetic acid, propionic acid, butyric acid, valeric acid, citric acid, tartaric acid, oxalic acid, lactic acid, malic acid, benzoic acid, formate, acetate, propionate, butyrate, valerate citrate, tartarate, oxalate, lactate, malate, maleic acid, maleate, phthalic acid, phthalate, benzoate, and combinations thereof.

12. The composition of claim 11, wherein said degradation promoter comprises citric acid and/or a sulfate.

13. A method for producing a degradable fiber, said method comprising:
(a) dissolving a cellulose ester having a total degree of substitution of 2.9 or less in a spinning solvent to form a dope; and
(b) spinning said dope to form said degradable fiber, wherein said degradable fiber exhibits a percent weight loss of not more than 50 percent after 0.25 days at 130° C. in deionized water and a percent weight loss of at least 65 percent after 7 days at 130° C. in deionized water.

14. The method of claim 13, wherein said spinning comprises dry-spinning.

15. The method of any one of claims 13-14, further comprising dissolving an additive in said dope.

16. The method of claim 15, wherein said additive comprises citric acid and/or a sulfate.

17. The method of claim 13, wherein said degradable fiber has a residual sulfur content of less than 5 wt %.

18. The method of claim 13, wherein said cellulose ester comprises an acetate substituent, a propionate substituent, a butyrate substituent, or a combination thereof.

19. The method of claim 13, wherein said cellulose ester comprises cellulose acetate.

20. The method of any one of claim 13, 18 or 19, wherein the cellulose ester has a number average molecular weight (“Mₙ”) in the range of from about 15,000 Da to about 60,000 Da.

21. The method of claim 13, wherein said degradable fiber does not comprise a plasticizer.

22. The method of claim 13, wherein said degradable fiber does not comprise a coating.
